(19) United States
(12) Patent Application Publication
(10) Pub. No.: US 2007/0157849 A1
(43) Pub. Date: Jul. 12, 2007

(54) Recording liquids

(75) Inventors: Michael Kluge, Ludwigshafen (DE); Ulrike Hees, Mannheim (DE); Dieter Freyberg, Einselthum (DE); Ralf Schomber, Edenkoben (DE); Clarissa Seidl, Sinsheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Akiengesellschaft, Ludwigshafen (DE)

(21) Appl. No.: 10/589,737

(22) PCT Filed: Feb. 19, 2005
(86) PCT No.: PCT/EP05/01759

§ 371 Date: Aug. 17, 2006

(30) Foreign Application Priority Data
Feb. 26, 2004 (DE) 10 2004 009 940.5

(51) Int. Cl. C09D 11/00

(52) U.S. Cl. 106/31.33; 106/31.65

(57) ABSTRACT

Aqueous recording fluids comprise (a) at least one colorant which is not completely polymer enveloped, (b) at least two wetting agents selected from alkoxylated alcohols, alkoxylated acetylene alcohols, alkoxylated or nonalkoxylated acetylenediols, alkylpolyglucosides, sugar ester alkoxylates, fluorosurfactants, anionic surfactants and cationic surfactants.

The present invention relates to aqueous recording fluids comprising
(a) at least one colorant which is not completely polymer enveloped,
(b) at least two wetting agents selected from alkoxylated alcohols, alkoxylated acetylene alcohols, alkoxylated or nonalkoxylated acetylenediols, alkylpolyglucosides, sugar ester alkoxylates, fluorosurfactants, anionic surfactants and cationic surfactants.

Recording fluids and especially inks which are used in the ink jet process (such as Thermal Ink Jet, Piezo Ink Jet, Continuous Ink Jet, Valve Jet, transfer printing processes) have to meet a whole series of requirements: They have to have viscosity and surface tension suitable for printing, they have to be stable in storage, i.e., they should not coagulate or flocculate, and they must not lead to cloggage of printer nozzles, which can be problematical especially in the case of inks containing dispersed, i.e., undissolved, colorant particles. Stability in storage further requires of these recording fluids and especially inks that the dispersed colorant particles do not sediment. Furthermore, in the case of Continuous Ink Jet, the inks shall be stable to the addition of conducting salts and be free from any tendency to floc out with an increase in the ion content. In addition, the prints obtained have to meet colorists' requirements, i.e., show high brilliance and depth of shade, and have good fastnesses, for example rubfastness, lighffastness, waterfastness and wet rubfastness, if appropriate after aftertreatment such as fixation for example, and good drying characteristics.

It is a further requirement that the inks dry rapidly on the substrate in order that images or characters to be printed do not bleed and for example the ink droplets of different colors do not mingle. The production of needle-sharp prints requires in this connection not only print dry time minimization but also bleed control for the ink droplets on the substrate during the print dry time. An ink where the droplets do not bleed is said to have good holdout. Prior art ink holdout or print definition leaves something to be desired.

EP 1 153 992 describes pigmented inks wherein pigment particles are enveloped with a resin which has an anionic group, the ink comprising 0.1% to % by weight of an acetylene glycol surfactant and or/a polysiloxane of the formula A1 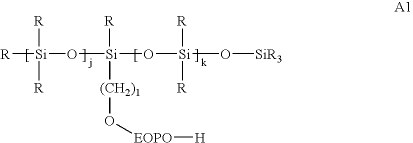
as well as enveloped pigment. In the formula diagram shown, j and k are each 1 or more, the R radicals are the same or different and are each C₁-C₆-alkyl and EOPO-H represents at least one ethylene oxide unit or at least one propylene oxide unit or at least one polyalkylene oxide unit in which ethylene oxide and propylene oxide units may be arranged randomly or in block form.

EP 1 234 859 claims a pigmented ink comprising at least one compound of the general formula A2 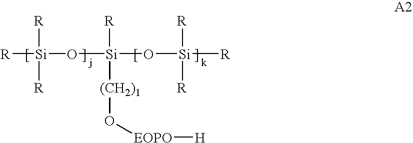
where the variables are each as defined above.

U.S. 6,241,811 claims an ink formulation comprising an alkoxylated or nonalkoxylated acetylene glycol compound.

EP 1 333 048 discloses ink formulations having solids contents in the range from 20% to 60% which each comprise a specifically substituted acetylenediol.

EP 1 295 916 discloses inks for the ink jet process which comprise a completely polymer-enveloped pigment or a completely polymer-enveloped dye, water and at least one specific compound selected from acetylene glycol compounds, acetylene alcohols, glycol ethers or 1,2-alkylene glycols. Completely pblymer-enveloped pigments and dyes are disclosed by EP 1 295 916 to be made for example by preparing the required polymer in the presence of the respective pigment and dye to be completely enveloped. The use of completely polymer-enveloped pigment is essential according to EP 1 295 916 because it is otherwise not possible to attain satisfactory images (page 12 line 54 to page 13 line 4).

However, it has been determined that the printing properties of prior art inks are still in need of improvement. For example, some prior art inks are still very prone to foam.

The present invention has for its object to provide recording fluids and especially inks for the ink jet process which do not have the disadvantages mentioned above. The present invention further has for its object to provide a process for producing improved recording fluids and especially inks for the ink jet process. The present invention further has for its object to provide printed substrates.

We have found that this object is achieved by the recording fluids defined at the beginning.

In what follows, recording fluids will also be referred to as inks and inks for the ink jet process.

The recording fluids of the present invention comprise at least one colorant preferably in particulate form a), for example pigments or disperse dyes. Pigments for the purposes of the present invention are virtually insoluble, finely dispersed, organic or inorganic colorants as per the definition in German standard specification DIN 55944.

Representative examples of pigments are

| | |
|---|---|
| monoazopigments: | C.I. Pigment Brown 25; C.I. Pigment Orange 5, 13, 36 |
| | and 67; C.I. Pigment Red 1, 2, 3, 5, 8, 9, 12, 17, 22, 23, |
| | 31, 48:1, 48:2, 48:3, 48:4, 49, 49:1, 52:1, 52:2, 53, 53:1, |
| | 53:3, 57:1, 63, 112, 146, 170, 184, 210, 245 and 251; C.I. |
| | Pigment Yellow 1, 3, 73, 74, 65, 97, 151 and 183; |
| disazo pigments: | C.I. Pigment Orange 16, 34 and 44; C.I. Pigment Red |
| | 144, 166, 214 and 242; C.I. Pigment Yellow 12, 13, 14, |
| | 16, 17, 81, 83, 106, 113, 126, 127, 155, 174, 176 and |
| | 188; |
| anthanthrone pigments: | C.I. Pigment Red 168 (C.I. Vat Orange 3); |
| anthraquinone pigments: | C.I. Pigment Yellow 147 and 177; C.I. Pigment Violet 31; |
| anthraquinone pigments: | C.I. Pigment Yellow 147 and 177; C.I. Pigment Violet 31; |
| anthrapyrimidine pigments: | C.I. Pigment Yellow 108 (C.I. Vat Yellow 20); |
| quinacridone pigments: | C.I. Pigment Red 122, 202, and 206; C.I. Pigment |
| | Violet 19; |
| quinophthalone pigments: | C.I. Pigment Yellow 138; |
| dioxazine pigments: | C.I. Pigment Violet 23 and 37; |
| flavanthrone pigments: | C.I. Pigment Yellow 24 (C.I. Vat Yellow 1); |
| indanthrone pigments: | C.I. Pigment Blue 60 (C.I. Vat Blue 4) and 64 (C.I. |
| | Vat Blue 6); |
| isoindoline pigments: | C.I. Pigment Orange 69; C.I. Pigment Red 260; C.I. |
| | Pigment Yellow 139 and 185; |
| isoindolinone pigments: | C.I. Pigment Orange 61; C.I. Pigment Red 257 and |
| | 260; C.I. Pigment Yellow 109, 110, 173 and 185; |
| isoviolanthrone pigments: | C.I. Pigment Violet 31 (C.I. Vat Violet 1); |
| metal complex pigments: | C.I. Pigment Yellow 117, 150 and 153; C.I. Pigment |
| | Green 8; |
| perinone pigments: | C.I. Pigment Orange 43 (C.I. Vat Orange 7); C.I. |
| | Pigment Red 194 (C.I. Vat Red 15); |
| perylene pigments: | C.I. Pigment Black 31 and 32; C.I. Pigment Red |
| | 123, 149, 178, 179 (C.I. Vat Red 23), 190 (C.I. Vat |
| | Red 29) and 224; C.I. Pigment Violet 29; |
| phthalocyanine pigments: | C.I. Pigment Blue 15, 15:1, 15:2, 15:3, 15:4, 15:6 |
| | and 16; C.I. Pigment Green 7 and 36; |
| pyranthrone pigments: | C.I. Pigment Orange 51; C.I. Pigment Red 216 (C.I. |
| | Vat Orange 4); |
| thioindigo pigments: | C.I. Pigment Red 88 and 181 (C.I. Vat Red 1); C.I. |
| | Pigment Violet 38 (C.I. Vat Violet 3); |
| triarylcarbonium pigments: | C.I. Pigments Blue 1, 61 and 62; C.I. Pigment Green |
| | 1; C.I. Pigment Red 81, 81:1 and 169; C.I. Pigment |
| | Violet 1, 2, 3 and 27; C.I. Pigment Black 1 (aniline |
| | black); |
| | C.I. Pigment Yellow 101 (aldazine yellow); |
| | C.I. Pigment Brown 22. |

Examples of inorganic pigments are:

| | |
|---|---|
| white pigments: | titanium dioxide (C.I. Pigment White 6), zinc white, pigment |
| | grade zinc oxide; zinc sulfide, lithopone; lead white; |
| black pigments: | iron oxide black (C.I. Pigment Black 11), iron manganese |
| | black, spinell black (C.I. Pigment Black 27); carbon black |
| | (C.I. Pigment Black 7); |
| chromatic pigments: | chromium oxide, chromium oxide hydrate green; chrome |
| | green (C.I. Pigment Green 48); cobalt green (C.I. Pigment |
| | Green 50); ultramarine green; cobalt blue (C.I. Pigment Blue |
| | 28 and 36); ultramarine blue; iron blue (C.I. Pigment Blue |
| | 27); manganese blue; ultramarine violet; colbalt violet; |
| | manganese violet; iron oxide red (C.I. Pigment Red 101); |
| | cadmium sulfoselenide (C.I. Pigment Red 108); molybdate |
| | red (C.I. Pigment Red 104); ultramarine red; |
| | iron oxide brown, mixed brown, spinell and corundum |
| | phases (C.I. Pigment Brown 24, 29 and 31), chrome orange; |
| | iron oxide yellow (C.I. Pigment Yellow 42); nickel titanium |
| | yellow (C.I. Pigment Yellow 53; C.I. Pigment Yellow 157 and |
| | 164); chrome titanium yellow; cadmium sulfide and cadmium |
| | zinc sulfide (C.I. Pigment Yellow 37 and 35); chrome yellow |
| | (C.I. Pigment Yellow 34), zinc yellow, alkaline earth metal |
| | chromates; Naples yellow; bismuth vanadate (C.I. Pigment |
| | Yellow 184); |
| interference pigments: | metallic effect pigments based on coated metal platelets; |
| | pearl luster pigments based on mica platelets coated with |
| | metal oxide; liquid crystal pigments. |

Preferred pigments in this context are monoazo pigments (especially laked BONS pigments, naphthol AS pigments), disazo pigments (especially diaryl yellow pigments, bisacetoacetanilide pigments, disazopyrazolone pigments), quinacridone pigments, quinophthalone pigments, perinone pigments, phthalocyanine pigments, triarylcarbonium pigments (alkali blue pigments, laked rhodamines, dye salts with complex anions), isoindoline pigments and carbon blacks.

Specific examples of particularly preferred pigments are: C.I. Pigment Yellow 138, C.I. Pigment Red 122, C.I. Pigment Violet 19, C.I. Pigment Blue 15:3 and 15:4, C.I. Pigment Black 7, C.I. Pigment Orange 5, 38 and 43 and C.I. Pigment Green 7.

The pigments recited above are advantageously useful for preparing ink jet ink sets based on the recording fluids of the present invention. The level of the particular pigments in the individual recording fluids or inks must be adapted to the particular requirements (trichromatic coloration, for example), i.e., cyan, magenta, yellow and black pigments have to be coordinated with each other with regard to content.

The following pigment combinations are particularly commendable for trichromatic requirements:

C.I. Pigment Yellow 138, C.I. Pigment Violet 19, C.I. Pigment Blue
15:3 and C.I. Pigment Black 7;
C.I. Pigment Yellow 138, C.I. Pigment Red 122, C.I. Pigment Blue
15:3 or 15:4 and C.I. Pigment Black 7;
C.I. Pigment Yellow 138, C.I. Pigment Violet 19, C.I. Pigment Blue
15:3, C.I. Pigment Black 7, C.I. Pigment Orange 43 and C.I. Pigment
Green 7; C.I. Pigment Yellow 138, C.I. Pigment Red 122, C.I. Pigment
Blue 15:3 or 15:4, C.I. Pigment Black 7, C.I. Pigment Orange 5 and
C.I. Pigment Green 7;
C.I. Pigment Yellow 138, C.I. Pigment Red 122, C.I. Pigment Blue 15:3
or 15:4, C.I. Pigment Black 7, C.I. Pigment Orange 38 and C.I. Pigment
Green 7;
C.I. Pigment Yellow 138, C.I. Pigment Red 122, C.I. Pigment Blue 15:3
or 15:4, C.I. Pigment Black 7, C.I. Pigment Orange 43 and C.I. Pigment
Green 7.

Specific Examples of Representative Disperse Dyes Are:
C.I. Disperse Yellow 2, 4, 5, 6, 7, 8, 10, 11, 11:1, 12, 13, 14, 15, 16, 17, 18, 19, 20, 21, 22, 23, 24, 25, 26, 27, 28, 29, 30, 31, 32, 33, 34, 35, 36, 37, 38, 40, 41, 42, 43, 44, 45, 46, 47, 48, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 179, 180, 181, 182, 183, 184, 184:1, 198, 200, 201, 202, 203, 204, 205, 206, 207, 208, 209, 210, 211, 212, 213, 214, 215, 216, 217, 218, 219, 220, 221, 222, 223, 224, 225, 226, 227 and 228;
C.I. Disperse Orange 2, 4, 5, 6, 7, 8, 9, 10, 12, 13, 14, 15, 16, 17, 18, 19, 20, 21, 22, 23, 24, 25, 25:1, 26, 27, 28, 29, 30, 31, 32, 33, 34, 35, 36, 38, 39, 40, 41, 41:1, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 77, 78, 79, 80, 81, 82, 83, 84, 85, 86, 87, 88, 89, 90, 91, 126, 127, 128, 129, 130, 131, 136, 137, 138, 139, 140, 141, 142, 143, 145, 146, 147 and 148;
C.I. Disperse Red 2, 3, 4, 5, 5:1, 6, 7, 8, 9, 10, 12, 13, 14, 15, 16, 18, 19, 20, 21, 22, 23, 24, 25, 26, 27, 28, 29, 30, 30:1, 31, 32, 33, 34, 35, 36, 38, 39, 40, 41, 43, 43:1, 46, 48, 50, 51, 52, 53, 54, 55, 55:1, 56, 58, 59, 60, 61, 63, 65, 66, 69, 70, 72, 73, 74, 75, 76, 77, 79, 80, 81, 82, 84, 85, 86, 86:1, 87, 88, 89, 90, 91, 92, 93, 94, 96, 97, 98, 100, 102, 103, 104, 105, 106, 107, 108, 109, 110, 111, 112, 113, 115, 116, 117, 118, 120, 121, 122, 123, 125, 126, 127, 128, 129, 130, 131, 132, 133, 134, 135, 136, 137, 138, 139, 140, 141, 142, 143, 144, 145, 146, 147, 148, 149, 150, 151, 151:1, 152, 153, 154, 155, 156, 157, 158, 159, 160, 161, 162, 163, 164, 165, 166, 167, 167:1, 168, 169, 170, 171, 172, 173, 174, 175, 176, 177, 178, 179, 180, 181, 182, 183, 184, 185, 186, 187, 188, 189, 190, 190:1, 191, 191:1, 192, 193, 194, 195, 211, 223, 224, 273, 274, 275, 276, 277, 278, 279, 280, 281, 302:1, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 338, 339, 340, 341, 342, 343, 344, 346, 347, 348, 349, 352, 356 and 367;
C.I. Disperse Violet 1, 2, 3, 4, 4:1, 5, 6, 7, 8, 9, 10, 11, 12, 13, 14, 15, 16, 17, 18, 19, 20, 21, 22, 23, 24, 25, 26, 27, 28, 29, 31, 33, 34, 35, 36, 37, 38, 39, 40, 41, 42, 43, 44, 45, 46, 47, 48, 49, 50, 51, 52, 53, 54, 55, 56, 57, 58, 59, 60, 70, 81, 86, 87, 88, 89, 91, 92, 93, 94, 96 and 97;
C.I. Disperse Blue 2, 4, 5, 6, 8, 9, 10, 11, 12, 13, 13:1, 14, 15, 16, 17, 18, 19, 20, 21, 22, 23, 23:1, 24, 25, 27, 28, 29, 30, 31, 32, 33, 34, 36, 38, 39, 40, 42, 43, 44, 45, 47, 48, 49, 51, 52, 53, 54, 55, 56, 58, 60, 60:1, 61, 62, 63, 64, 64:1, 65, 66, 68, 70, 72, 73, 75, 76, 77, 79, 80, 81, 81:1, 82, 83, 84, 85, 86, 87, 88, 89, 90, 91, 92, 93, 94, 95, 96, 97, 98, 99, 100, 101, 103, 104, 105, 107, 108, 109, 111, 112, 113, 114, 115, 116, 117, 118, 119, 121, 122, 123, 125, 126, 127, 128, 130, 131, 132, 133, 134, 136, 137, 138, 139, 140, 141, 142, 143, 144, 145, 146, 147, 148, 149, 150, 151, 152, 153, 154, 155, 156, 158, 159, 160, 161, 162, 163, 164, 165, 165:2, 166, 167, 168, 169, 170, 171, 172, 173, 174, 175, 195, 281, 282, 283, 283:1, 284, 285, 286, 287, 288, 289, 290, 291, 292, 293, 294, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 349, 351 and 359;
C.I. Disperse Green 1, 2, 5, 6 and 9;
C.I. Disperse Brown 1, 2, 3, 4, 4:1, 5, 7, 8, 9, 10, 11, 18, 19, 20 and 21;
C.I. Disperse Black 1, 3, 4, 5, 6, 7, 8, 9, 10, 11, 12, 13, 14, 15, 20, 22, 24, 25, 26, 27, 28, 29, 29:1, 30, 31, 32, 33, 34 and 36;

Also suitable are the substituted benzodifuranone dyes whose basic structure conforms to the formula B.

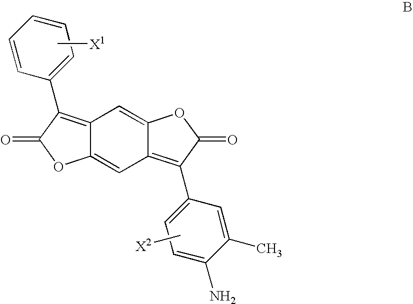

Such dyes may be substituted on either or both of the phenyl rings. Useful substituents X¹ and x² include halogen, alkyl with or without interruption by nonadjacent oxygen atoms, alkoxy with or without interruption by oxygen atoms and substitution in the alkyl moiety, hydroxyl, substituted or unsubstituted amino, cyano, nitro and alkoxycarbonyl.

Also suitable is the dye of the following formula C:

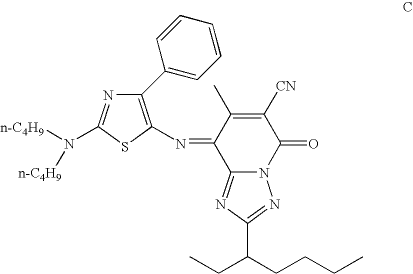

Further examples of suitable disperse dyes are recited in WO 97/46623, WO 98/24850 and WO 99/29783.

The recording fluids of the present invention may comprise mixtures of two or more different colorants. Preferably, however, the recording fluids of the present invention do not comprise mixtures of two or more different colorants, but only one colorant.

The recording fluids of the present invention comprise colorants which are preferably in particulate form, i.e., in the form of particles. The particles may be regular or irregular in shape in that, for example, the particles may have a spherical or substantially spherical shape or a needle (acicular) shape.

Colorants in particulate form which are included in the recording fluids of the present invention should be very finely divided. It is preferable for 95% by weight and more preferable for 99% by weight of the colorant particles to have a median particle diameter of less than 1 μm, preferably of less than 0.5 μm and especially of 0.3 μm.

In a preferred embodiment of the present invention, an inventive recording fluid comprises from 10 to 100 g/l and preferably from 12 to 70 g/l of colorant in preferably particulate form.

In a preferred embodiment of the present invention, recording fluids according to the present invention comprise at least one colorant in non-completely polymer-enveloped form; that is, at least one colorant is not completely polymer enveloped. For the purposes of the present invention, non-completely polymer-enveloped colorants may for example be those colorants in particulate form where some colorant particles are completely polymer enveloped and others only incompletely. Non-completely polymer-enveloped colorants for the purposes of the present invention may for example also be colorants wherein some colorant particles are completely polymer enveloped and others not at all. Furthermore, non-completely polymer-enveloped colorants may for example also be understood as referring to colorants in particulate form which are not at all polymer enveloped.

In a particularly preferred embodiment of the present invention, non-completely polymer-enveloped colorant shall refer to colorants wherein at least 0.1% by weight of colorant particles are not completely polymer enveloped, as is detectable for example by well-known methods, for example ultracentrifugation or TEM on samples selected to be representative.

Aqueous recording fluids according to the present invention further comprise

(b) at least two wetting agents selected from alkoxylated alcohols, alkoxylated acetylene alcohols, alkoxylated or nonalkoxylated acetylenediols, alkylpolyglucosides, sugar ester alkoxylates, anionic surfactants and cationic surfactants.

Alkoxylated alcohols for the purposes of the present invention are singly or multiply, preferably up to 30-tuply alkoxylated alcohols of the general formula I
R¹—O-(AO)ₓ—H I
where:
R¹ is selected from C₅-C₃₀-alkyl, unsubstituted or substituted with one or two hydroxyl groups, wherein one or else two nonadjacent CH₂ groups may be replaced by oxygen, examples being n-pentyl, iso-pentyl, iso-amyl, n-hexyl, n-heptyl, n-octyl, 2-ethylhexyl, n-nonyl, n-decyl, iso-decyl, n-undecyl, n-dodecyl, n-tridecyl, n-tetradecyl, n-pentadecyl, n-hexadecyl, n-octadecyl, n-eicosyl and the radicals Ia to Ic 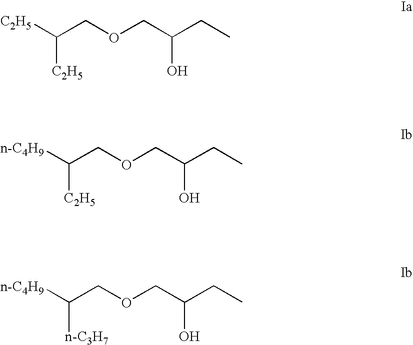
AO represents identical or different alkylene oxide units, for example propylene oxide units, butylene oxide units and especially ethylene oxide units.
x is an integer in the range from 1 to 100, preferably up to 50 and more preferably from 2 to 30.

Alkoxylated acetylene alcohols are preferably compounds of the general formula 11 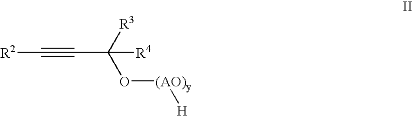
where:
R² is selected C₁-C₁₀-alkyl, branched or unbranched, such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl, more preferably C₁-C₄-alkyl such as methyl, ethyl, n-propyl, iso-propyl, n-butyl, iso-butyl, sec-butyl and tert-butyl;
   and hydrogen;
R³ and R⁴ are the same or different and selected from C₁-C₁₀-alkyl, branched or unbranched, such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl, more preferably C₁-C₄-alkyl such as methyl, ethyl, n-propyl, iso-propyl, n-butyl, iso-butyl, sec-butyl and tert-butyl;
   and hydrogen;
y is an integer in the range from 1 to 100, preferably up to 50 and more preferably from 2 to 30.

In a preferred embodiment of the present invention R³ and R⁴ are each or both not hydrogen.

In a preferred embodiment of the present invention R³ and R⁴ are each or both methyl.

In a particularly preferred embodiment of the present invention R³ is methyl and R⁴ is C₁-C₁₀-alkyl.

AO is as defined above.

Alkoxylated or nonalkoxylated acetylenediols are preferably compounds of the general formula III 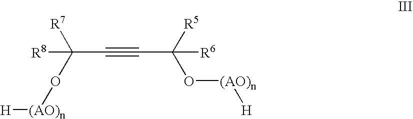
where:
R⁵, R⁶, R⁷, R⁸ are each the same or different and selected from C₁-C₁₀-alkyl, branched or unbranched, such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl, more preferably C₁-C₅-alkyl such as methyl, ethyl, n-propyl, iso-propyl, n-butyl, iso-butyl, sec-butyl, tert-butyl and isopentyl;
   and hydrogen;
n is at each occurrence the same or different and selected from integers in the range from 0 to 50, preferably 0 or 1 to 30 and more preferably 3 to 20;

AO is as defined above.

In a preferred embodiment of the present invention R⁵ and R⁷ are both not hydrogen.

In a preferred embodiment of the present invention R⁵ or R⁷ is methyl.

In a particularly preferred embodiment of the present invention R⁵ and R⁷ are both methyl and R⁶ and R⁸ are both C₁-C₁₀-alkyl, especially isobutyl.

An alkylpolyglucoside for the purposes of the present invention is preferably a glucose etherified with C₁-C₂₀-alkanol and preferably with C₁₂-C₂₀-alkanol at the C1 position. Their manufacturing operation is such that alkylpolyglucosides are generally contaminated with C₁-C₆-linked di- and polyglucosides which may be etherified with C₁-C₂₀-alkanol. In a preferred embodiment of the present invention 1.3 equivalents of sugar are linked with one equivalent of C₁-C₂₀-alkanol.

Sugar ester alkoxylates for the purposes of the present invention are preferably sugar alcohols esterified singly or multiply with fatty acids and alkoxylated with 5 to 80 equivalents of alkylene oxide, especially with ethylene oxide. Preferred sugar ester alkoxylates are selected from alkoxylated sorbitan fatty acids, preferably sorbitol singly or multiply esterified with fatty acids and alkoxylated with 5 to 80 equivalents of alkylene oxide, especially ethylene oxide.

Fluorosurfactants for the purposes of the present invention are preferably perfluoro-C₈-C₉-carboxylic acids in the form of their alkali metal salts and preferably their sodium salts.

Anionic surfactants for the purposes of the present invention are preferably fatty acid salts, especially alkali metal salts of fatty acids such as for example stearic acid and palmitic acid.

Cationic surfactants for the purposes of the present invention are preferably C₈-C₂₀-alkyltrimethylammonium salts, especially chlorides or bromides.

Above-recited alkoxylated alcohols, alkoxylated acetylene alcohols, acetylene glycols and sugar ester alkoxylates are typically synthesized in the form of mixtures, and the components of the as-synthesized mixtures typically differ in their degree of alkoxylation. The variables x, y and n therefore represent the number average degree of alkoxylation, which can be determined by methods known to one skilled in the art, such as gel permeation chromatography (GPC) for example. A mixture obtained by customary synthesis is for the purposes of the present invention not defined as two different wetting agents.

In one embodiment of the present invention colorant preparations according to the present invention comprise up to 5% by weight, based on the total weight of the recording fluid of the present invention, of wetting agents (b), preferably up to 2% by weight and more preferably up to 1.5% by weight.

In one embodiment of the present embodiment of the present invention recording fluids according to the present invention comprise up to 5 different wetting agents (b1), (b2), (b3), (b4) and (b5), preferably up to 3 different wetting agents (b1), (b2) and (b3), more preferably two wetting agents (b1) and (b2).

In a preferred embodiment of the present invention recording fluids according to the present invention comprise two different wetting agents (b1) and (b2) in weight fractions in the range from 1:20 to 20:1, preferably in the range from 1:10 to 10:1, and more preferably in the range from 1:5 to 5:1.

In one embodiment of the present invention recording fluids according to the present invention comprise

(c) at least one dispersant.

Useful dispersants further include maleic acid-acrylic acid copolymers, especially those having a molecular weight Mₙ in the range from 2000 to 10 000 g/mol, which are useful in the form of random copolymers or block copolymers. Useful dispersants further include N-vinylpyrrolidone homopolymers and acrylate-N-vinylpyrrolidine copolymers, especially those N-vinylpyrrolidone homopolymers and acrylate-N-vinylpyrrolidine copolymers having a molecular weight Mₙ in the range from 2000 to 10 000 g/mol, in the form of random copolymers or block copolymers.

Preferred examples of dispersants are for example alkoxylated and partially sulfated alkylphenols, for example the substances described in U.S. Pat. No. 4,218,218, or condensation products of naphthalenesulfonic acid and formaldehyde or mixtures of arylsulfonic acid-formaldehyde condensation products as described for example in U.S. Pat. No. 5,186,846.

Recording fluids according to the present invention may comprise for example from 0.1% to 20% by weight, preferably from 1% to 10% by weight and more preferably up to 5% by weight of dispersant, based on the total weight of recording fluid according to the present invention.

In one embodiment of the present invention recording fluids according to the present invention comprise

(d) at least one binder.

In one embodiment of the present invention recording fluids according to the present invention and especially ink jet process inks according to the present invention comprise binders. Binders can be selected from the group of the radiation-curable binders, the thermally curable binders and the air-drying binders. Useful binders are described for example in WO 99/01516 and WO 02/36695. Similarly, dispersing binder systems as in WO 03/29318 are useful as an additive.

Binders may additionally have dispersing properties, in which case they are herein also referred to as dispersing binders (dc). For the purposes of the present invention, they can supplement or replace dispersant (c) and binder (d) singly or as a combination.

Particularly suitable dispersing binders (dc) are those which are synthesizable from a combination consisting of one or more polyurethanes and one or more melamine resins. Useful polyurethanes are obtainable for example by reaction of one or more diisocyanates with one more diols having no further hydrophilic groups, for example ethylene glycol, propylene glycol or 1,4-cycylohexanedimethanol) and one or more diols having at least one hydrophilic group, for example a COOH group (incorporation of trimethylolpropanoic acid for example) or of an SO₃H group by methods known per se. Particularly useful diols without further hydrophilic groups are polyesterdiols obtainable for example by reaction of one or more dicarboxylic acids with one or more diols having no further hydrophilic groups.

Particularly useful melamine resins include for example those of the general formula IV

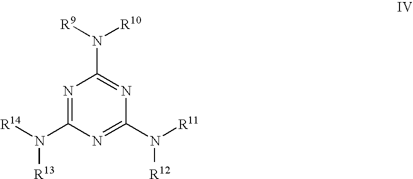

R⁹ to R¹⁴ are the same or different and selected from hydrogen or CH₂-OR¹⁵ or CH(OR¹⁵)₂ or CH₂-N(R¹⁵)₂

wherein R¹⁵ is at each occurrence the same or different and selected from

hydrogen,

C₁-C₁₂-alkyl, branched or unbranched;

alkoxyalkylene selected from (—CH₂—CH₂—O)_{w}—H, (—CHCH₃—CH₂—O)_{w}—H, (—CH₂—CHCH₃—O_{w}—H, (—CH₂—CH₂—CH₂—CH₂—O)_{w}—H, wherein w is an integer from 1 to 20.

Preferably, R⁹, R¹¹ and R¹³ are each hydrogen, and R¹⁰, R¹² and R¹⁴ are each not hydrogen.

Particularly useful melamine resins have the formula IV.1

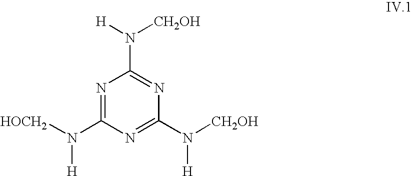

Melamine resins for the purposes of the present invention are generally not pure in the sense of having one defined formula; typically, there are intermolecular rearrangements of the R¹ to R⁶ radicals, i.e., transacetalization reactions and transaminalization reactions, and also, to a certain degree, condensation reactions and elimination reactions. The above-indicated formula IV and especially the formula IV.1 is to be understood as defining the stoichiometric ratios of the substituents and also comprises intermolecular rearrangement products and condensation products.

Useful binders, preferably in the form of dispersions or emulsions, include for example: radiation-curable, thermally curable or air-drying binders, i.e., chemically crosslinking binders, or physically drying binders wherein the liquid phase evaporates, for example water or an organic solvent.

Radiation-curable binders for inclusion in recording fluids of the present invention are curable by radiation of high energy, i.e., electromagnetic radiation especially from 220 to 450 nm, or electron beams. Free-radically and cationically polymerizable binders and also mixtures thereof are also suitable. Such binders are known as such and are described for example in Chemistry and Technology of UV and EB Formulation for Coatings, Inks and Paints, SITA Technology, London 1991; UV and EB Curing Formulation for Printing Inks and Paints, SITA Technology, London 1991, and Vinyl Ethers—The innovative Challenge, a 1997 publication from BASF Aktiengesellschaft.

Examples which may be mentioned of radiation-curable binders include acrylate, vinyl and epoxy monomers, prepolymers and polymers and mixtures thereof.

Acrylate binders are especially prepolymers based on acrylate or methacrylate, with acrylate-based prepolymers being particularly preferred.

Preferred acrylates and methacrylates comprise generally from 2 to 20, preferably from 2 to 10 and more preferably from 2 to 6 copolymerizable, ethylenically unsaturated double bonds per molecule. The average molecular weight Mₙ is preferably <15 000 g, more preferably <5000 g and most preferably in the range from 180 to 3000 g, determined by gel permeation chromatography (GPC) using polystyrene as standard and tetrahydrofuran as mobile phase.

As useful (meth)acrylate compounds there may be mentioned for example methacrylic esters and preferably acrylic esters of polyhydric alcohols, especially polyhydric alcohols which, besides the hydroxyl groups, comprise only ether groups or no further functional groups. Examples of such polyhydric alcohols are dihydric alcohols such as ethylene glycol, propylene glycol and also higher condensation products such as diethylene glycol, triethylene glycol, dipropylene glycol, tripropylene glycol, also 1,3-propanediol, 1,2-butanediol, 1,4-butanediol, 1,2-pentanediol, 1,2-hexanediol, 1,6-hexanediol, neopentylglycol, alkoxylated phenols and bisphenols such as for example ethoxylated bisphenol A, cyclohexanedimethanol. Also suitable are trihydric alcohols such as for example glycerol, trimethylolpropane, 1,2,4-butanetriol, 1,2,3-butanetriol or trimethylolethane.

As methacrylate compounds there may further be mentioned polyester (meth)acrylates, polyester (meth)acrylates being methacrylic esters of polyesterols, which can be saturated or unsaturated.

Useful polyesterols are prepared for example by esterification of di- and polycarboxylic acids, preferably dicarboxylic acids, with polyols. Preferred dicarboxylic acids are succinic acid, glutaric acid, adipic acid, sebacic acid, maleic acid, fumaric acid, phthalic acid, its isomers and hydrogenation products and also esterifiable derivatives such as for example anhydrides or dimethyl esters or diethyl esters of the acids mentioned above. Useful polyols include ethylene glycol, propylene glycol and also higher condensation products such as diethylene glycol, triethylene glycol, dipropylene glycol, tripropylene glycol, also 1,3-propanediol, 1,2-butanediol, 1,4-butanediol, 1,2-pentanediol, 1,2-hexanediol, 1,6-hexanediol, 1,4-cycloehexanedimethanol (mixed isomers) and also polyalkylene glycols based on ethylene glycol and propylene glycol.

An efficient process for producing the abovementioned (meth)acrylate compounds is described for example in EP-A 0 279 303.

The (meth)acrylate compounds may further be epoxy or urethane (meth)acrylates. Epoxy (meth)acrylates are obtainable for example by reaction of epoxidized olefins or mono-, di- or polyglycidyl ethers such as for example bisphenol A diglycidyl ether with acrylates are especially reaction products of hydroxyalkyl (meth)acrylates with di- or polyisocyanates.

The (meth)acrylate compounds may further be melamine (meth)acrylates or silicone (meth)acrylates.

The (meth)acrylate compounds may also be modified to be ionic, through attachment of acid groups or ammonium groups for example, or nonionic, for example through attachment of amino groups. They are also preferably employed in the form of aqueous dispersions or emulsions, known as such from EP-A 0 704 469 and EP-A 0 012 339. The (meth)acrylate compounds may further be mixed with so-called reactive diluents to adjust the viscosity. Useful reactive diluents include for example vinyl-containing monomers, especially

N-vinyl compounds such as N-vinylpyrrolidone, N-vinylcaprolactam and N-vinylformamide and

vinyl ethers, for example ethyl vinyl ether, propyl vinyl ether, n-butyl vinyl ether, isobutyl vinyl ether, sec-butyl vinyl ether, tert-butyl vinyl ether, amyl vinyl ether, 2-ethylhexyl vinyl ether, n-dodecyl vinyl ether, n-octadecyl vinyl ether and cyclohexyl vinyl ether, ethylene monoglycol vinyl ether and ethylene monoglycol divinyl ether, di-, tri- and tetraethylene glycol monovinyl and divinyl ethers, propylene glycol divinyl ether, polyethylene glycol divinyl ether, ethylene glycol n-butyl vinyl ether, triethylene glycol methyl vinyl ether, polyethylene glycol methyl vinyl ether, 1,4-butanediol monovinyl and divinyl ethers, 1,6-hexanediol monovinyl and divinyl ethers, cyclohexanedimethanol monovinyl and divinyl ethers, trimethylolpropane monovinyl and divinyl ethers, aminopropyl vinyl ether, diethylaminoethyl vinyl ether and polytetrahydrofuran divinyl ether;

vinyl esters, for example vinyl acetate, vinyl propionate, vinyl stearate, vinyl laurate, aromatic vinyl compounds, for example styrene, vinyltoluene, 2-n-butylstyrene, 4-n-butyistyrene and 4-n-decylstyrene;

and also acrylate-containing monomers, for example phenoxyethyl acrylate, tert-butylcyclohexyl acrylate, 1,6-hexanediol diacrylate, tripropylene glycol diacrylate and trimethylolpropane triacrylate.

Vinyl-containing compounds can also be used directly as cationically polymerizable binders.

Useful radiation-curable binders further include epoxy-containing compounds, for example cyclopentene oxide, cyclohexene oxide, epoxidized polybutadiene, epoxidized soybean oil, 3′,4′-epoxycyclohexylmethyl 3,4-epoxycyclohexane carboxylate and glycidyl ethers, for example 1,4-butanediol diglycidyl ether, 1,6-hexanediol diglycidyl ether, bisphenol A diglycidyl ether and pentaerythritol diglycidyl ether, in which case cationically polymerizable monomers, for example unsaturated aldehydes and ketones, dienes such as butadiene or isoprene, aromatic vinyl compounds such as styrene, N-substituted vinylamines such as N-vinylcarbazole and cyclic ethers such as tetrahydrofuran, can likewise be used as well.

In the particular case where the binder is to be cured by means of UV radiation, it is advisable to apply the binder to the print together with a photoinitiator to initiate the polymerization.

Useful photoinitiators for free-radical photopolymerizations include for example benzophenone and benzophenone derivatives such as for example 4-phenylbenzophenone or 4-chlorobenzophenone, acetophenone derivatives such as for example 2-hydroxy-2,2-dimethylacetophenone and 2,2-dimethoxy-2-phenylacetophenone, 1-benzoylcyclohexan-1-ol, benzoin and benzoin ethers such as methyl benzoin ether, ethyl benzoin ether and butyl benzoin ether, benzil ketals such as benzil dimethyl ketal, 2-methyl-1-[4-(methylthio)phenyl]-2-morpholinopropan-1-one, acylphosphine oxides such as 2,4,6-trimethylbenzoyldiphenylphophine oxide and bisacylphosphine oxides.

In one embodiment of the present invention recording fluids according to the present invention comprise from 0.1% to 20% by weight, preferably from 1% to 10% by weight and more preferably up to 5% by weight of binder, based on the total weight of the particular recording fluid.

Recording fluids according to the present invention may comprise organic solvents as further assistants (f).

Low molecular weight polytetrahydrofuran is a preferred solvent; it can be used alone or preferably mixed with one or more high-boiling water-soluble or—miscible organic solvents.

The preferred low molecular weight polytetrahydrofuran typically has an average molecular weight M_{w} in the range from 150 to 500 g/mol, preferably in the range from 200 to 300 g/mol and more preferably of about 250 g/mol (in keeping with a molecular weight distribution).

The preferred low molecular weight polytetrahydrofuran is preparable in known manner by cationic polymerization of tetrahydrofuran. The products are linear polytetramethylene glycols.

When the preferred low molecular weight polytetrahydrofuran is used as an additive in admixture with further organic solvents, the further organic solvents employed will generally be high-boiling and hence water-retaining organic solvents that are soluble in or miscible with water. High-boiling solvents generally have a boiling point >100° C. at atmospheric pressure.

Useful solvents further include polyhydric alcohols, preferably unbranched and branched polyhydric alcohols having from 2 to 8 and especially from 3 to 6 carbon atoms, such as ethylene glycol, 1,2-propylene glycol, 1,3-propylene glycol, 1,2-pentanediol, 1,2-hexanediol, 1,5-pentanediol, 1,6-hexanediol, glycerol, erythritol, pentaerythritol, pentitols such as arabitol, adonitol and xylitol and hexitols such as sorbitol, mannitol and dulcitol.

Useful solvents further include polyethylene glycols and polypropylene glycols (which is also to be understood as meaning the lower polymers (di-, tri- and tetramers)) and their mono (especially C₁-C₆, in particular C₁-C₄) alkyl ethers. Preference is given to polyethylene and polypropylene glycols having average molecular weights in the range from 100 to 1500 g/mol, especially in the range from 200 to 800 g/mol, and in particular in the range from 300 to 500 g/mol. Examples which may be mentioned are diethylene glycol, triethylene glycol, tetraethylene glycol, diethylene glycol monomethyl ether, diethylene glycol monoethyl ether, diethylene glycol monopropyl ether, diethylene glycol monobutyl ether, triethylene glycol monomethyl ether, triethylene glycol monoethyl ether, triethylene glycol monopropyl ether, triethylene glycol monobutyl ether, di-, tri- and tetra-1,2- and -1,3-propylene glycol and di-, tri- and tetra-1,2- and -1,3-propylene glycol monomethyl, monoethyl, monopropyl and monobutyl ethers.

Useful solvents further include pyrrolidone and N-alkylpyrrolidones whose alkyl chain preferably comprises from 1 to 4 and especially 1 or 2 carbon atoms. Examples of useful alkylpyrrolidones include N-methylpyrrolidone, N-ethylpyrrolidone and N-(2-hydroxyethyl)pyrrolidone.

Examples of particularly preferred solvents include 1,2-propylene glycol, 1,3-propylene glycol, glycerol, sorbitol, diethylene glycol, polyethylene glycol (M_{w} 300 to 500 g/mol), diethylene glycol monobutyl ether, triethylene glycol monobutyl ether, pyrrolidone, N-methylpyrrolidone and N-(2-hydroxyethyl)pyrrolidone.

The preferred low molecular weight polytetrahydrofuran can also be mixed with one or more (for example two, three or four) of the solvents recited above.

In one embodiment of the present invention recording fluids according to the present invention may comprise from 0% to 45% by weight, preferably from 5% to 30% by weight, more preferably from 10% to 25% by weight and most preferably from 10% to 20% by weight of one or more organic solvents, each percentage being based on the total weight of the recording fluid according to the present invention.

Organic solvents for the purposes of the present invention are liquid at room temperature.

Recording fluids according to the present invention in a specific version of the present invention comprise no organic solvents which have a boiling point below 247° C., measured at atmospheric pressure. By “no solvents” as used herein is meant that the fraction of organic solvents having a boiling point of below 247° C. that may be present as an impurity or as a contaminant is in total less than 0.1% by weight, preferably less than 0.05% by weight and more preferably less than 0.01% by weight. Examples of organic solvents having a boiling point below 247° C. are for example ethylene glycol, diethylene glycol, N-methylpyrrolidone, propylene glycol, propylene carbonate, diethylene monomethyl ether, diethylene monoethyl ether, diethylene mono-n-butyl ether, di-n-butyl ether, 1,2-dimethoxyethane, isopropanol and ethanol.

The organic solvent or solvents, including especially the particularly preferred solvent combinations mentioned, may advantageously be supplemented with urea (preferably from 0.1% to 5% by weight, based on the weight of the recording fluid according to the present invention or of the ink jet process ink according to the present invention) to further enhance the water-retaining effect of the solvent or solvent mixture.

Recording fluids according to the present invention may comprise further assistants (f) of the kind which are customary especially for aqueous ink jet inks and in the printing and coatings industry. Examples of such assistants include erythritol, pentitols such as arabitol, adonitol and xylitol and hexitols such as sorbitol, mannitol and dulcitol. Further examples are polyethylene glycols having an M_{w} in the range from more than 2000 g/mol to about 10 000 g/mol and preferably up to 800 g/mol. Further examples are preservatives such as for example 1,2-benzisothiazolin-3-one and its alkali metal salts, viscosity regulators, flow agents, wetters (e.g., wetting surfactants based on ethoxylated or propoxylated fatty or oxo alcohols, propylene oxide-ethylene oxide block copolymers, alkylphenol ether sulfates, alkylpolyglycosides, alkyl phosphonates, alkylphenyl phosphonates, alkyl phosphates, alkylphenyl phosphates, anti-settlers, luster improvers, lubricants, adhesion improvers, anti-skinning agents, delusterants, emulsifiers, stabilizers, hydrophobicizers, light control additives, hand improvers, antistats, bases such as for example K₂CO₃ or acids, specific carboxylic acids such as for example lactic acid or citric acid for regulating the pH. When these agents are part of recording fluids according to the present invention, their total amount will generally be up to 2% by weight and especially up to 1% by weight, based on the weight of the recording fluids according to the present invention.

In one embodiment of the present invention recording fluids according to the present invention have a dynamic viscosity in the range from 1 to 30 mPa·s, preferably in the range from 1 to 20 mPa·s and more preferably in the range from 2 to 15 mPa·s, determined at 20° C. in each case.

The surface tension of recording fluids according to the present invention at 20° C. is generally in the range from 20 to 70 mN/m, especially in the range from 20 to 40 mN/m and more preferably in the range from 25 to 35 mN/m.

The pH of recording fluids according to the present invention is generally in the range from 5 to 10 and preferably in the range from 7 to 9.

Recording fluids according to the present invention comprise (e) water, preferably deionized (demineralized or completely ion-free) water. They are therefore referred to herein as aqueous recording fluids. The preferred water content is not less than 30% by weight, preferably not less than 45% by weight and more preferably not less than 65% by weight.

In one embodiment of the present invention recording fluids according to the present invention comprise less than 500 ppm of free heavy metal ions, preferably less than 400 ppm, based in each case on the mass of the recording fluid according to the present invention. Specific examples of heavy metal ions are Cu²⁺, Co²⁺, Co³⁺, Fe²⁺, Fe³⁺, Ni²⁺, Zn²⁺, Ca²⁺. More particularly, recording fluids according to the present invention and ink jet process inks according to the present invention comprise up to 300 ppm of iron.

Recording fluids according to the present invention which have a heavy metal ion content of less than 500 ppm are producible for example by using purified pigments or by employing steps such as precipitating, salting out, ion exchange processes, filtration, electrolytic processes or other conventional deionization processes during the production of recording fluids according to the present invention. It is similarly possible to use appropriately purified organic solvent and completely ion-free water.

In one embodiment of the present invention recording fluids according to the present invention comprise less than 0.05% by weight of chloride, determined as sodium chloride.

Recording fluids according to the present invention which are used as inks for the ink jet process are observed to have a very small surface tension difference in the short-term range (0.1 seconds or less), meaning that, when the dynamic surface tension is determined according to German industrial standard DIN 53914, the values obtained are close to the static surface tension. In other words, the difference between static and dynamic surface tension after 0.1 seconds or sooner is generally in the range from 0.01 to 0.45 mN/m and preferably in the range from 0.1 to 0.4 mN/m.

A further aspect of the present invention is a process for producing recording fluids according to the present invention, hereinafter also referred to as production process according to the present invention. The production process according to the present invention customarily comprises one or more steps in which components of recording fluids according to the present invention are mixed. Such steps are carried out in customary mixing apparatuses, for example dissolvers, tanks and mills, including roll mills, ball mills or stirred media mills.

In one embodiment of the present invention the production process according to the present invention comprises mixing
(a) at least one colorant which is not completely polymer enveloped,
(b) at least 2 wetting agents selected from alkoxylated alcohols, alkoxylated acetylene alcohols, alkoxylated or nonalkoxylated acetylenediols, alkylpolyglucosides, sugar ester alkoxylates, fluorosurfactants, anionic surfactants and cationic surfactants,
(c) if appropriate at least one dispersant,
(d) if appropriate at least one binder,
(e) water and
(f) if appropriate further assistants
   with each other in one or more steps.

In one embodiment of the production process according to the present invention at least one colorant (a) which is non-completely polymer enveloped and is for example in the form of an aqueous press cake is premixed together with water (e) in a suitable apparatus, for example a dissolver. The resulting mixture is subsequently dispersed, for example in a mill or in a shaking apparatus, to achieve the desired particle size for the colorant or colorants (generally a number average diameter up to 1 μm, preferably up to 0.5 μm and more preferably up to 0.2 μm). This is followed by the addition of at least two wetting agents (b) and if appropriate further assistants (f) and if appropriate further water (e).

In another embodiment of the production process according to the present invention at least one colorant (a) which is non-completely polymer enveloped and is for example in the form of an aqueous press cake is premixed together with at least one dispersant (c) and water (e) in a suitable apparatus, for example a dissolver. The resulting mixture is subsequently dispersed, for example in a mill or in a shaking apparatus, to achieve the desired particle size for the colorant or colorants (generally a number average diameter up to 1 μm, preferably up to 0.5 μm and more preferably up to 0.3 μm). This is followed by the addition of at least two wetting agents and if appropriate further assistants (f) and if appropriate further water (e).

In another embodiment of the production process according to the present invention at least one colorant (a) which is non-completely polymer enveloped and is for example in the form of an aqueous press cake is premixed together with at least one dispersant (c) and water (e) in a suitable apparatus, for example a dissolver. The resulting mixture is subsequently dispersed, for example in a mill or in a shaking apparatus, to achieve the desired particle size for the colorant or colorants (generally a number average diameter up to 1 μm, preferably up to 0.5 μm and more preferably up to 0.3 μm). This is followed by the addition of at least two wetting agents, at least one binder (d), and if appropriate further assistants (f) and if appropriate further water (e).

In another version of the production process according to the present invention a colorant, a binder, which may have dispersing properties (dc), and water (e) are premixed in a suitable apparatus, for example a dissolver. The resulting mixture is subsequently dispersed, for example in a mill or in a shaking apparatus, to achieve the desired particle size for the colorant or colorants (generally a number average diameter of up to 1 μm, preferably up to 0.5 μm and more preferably up to 0.3 μm). This is followed by the addition of at least two wetting agents, if appropriate further assistants (f) and if appropriate further water (e).

In a preferred version of the production process according to the present invention a colorant, a binder, which may have dispersing properties (dc), an assistant (f) such as preferably polyethylene glycol and water (e) are premixed in a suitable apparatus, for example a dissolver. The resulting mixture is subsequently dispersed, for example in a mill or in a shaking apparatus, to achieve the desired particle size for the colorant or colorants (generally a number average diameter of up to 1 μm, preferably up to 0.5 μm and more preferably up to 0.3 μm). This is followed by the addition of at least two wetting agents, if appropriate further assistants (f) and if appropriate further water (e).

In a preferred version of the production process according to the present invention a colorant, a binder (d), an assistant (f) such as preferably polyethylene glycol and water (e) are premixed in a suitable apparatus, for example a dissolver. The resulting mixture is subsequently dispersed, for example in a mill or in a shaking apparatus, to achieve the desired particle size for the colorant or colorants (generally a number average diameter of up to 1 μm, preferably up to 0.5 μm and more preferably up to 0.3 μm). This is followed by the addition of at least two wetting agents, if appropriate further assistants (f) and if appropriate further water (e).

The final step in each case can be a filtration through filtering means with fines removal in the range from 1 to 0.5 μm. This is one way of obtaining recording fluids according to the present invention and especially ink jet inks according to the present invention.

Recording fluids according to the present invention can be used directly as inks or to produce inks, for example for the ink jet process. Recording fluids according to the present invention can especially be used directly as or to produce ink jet process inks. Other suitable inks are for example inks for fountain pens.

To use recording fluids according to the present invention to produce inks, the next step will generally be for recording fluids according to the present invention to be diluted, for example with water which may comprise one or more further of the assistants (f) mentioned above. Diluting may be accompanied by mixing, for example stirring.

A further aspect of the present invention is a process for printing substrates, which can be sheetlike or three dimensional for example, by the ink jet process using recording fluids according to the present invention or inks according to the present invention. To this end, ink jet process inks according to the present invention are printed on the substrate and the print obtained can subsequently be fixed.

In the ink jet process, inks are sprayed as small droplets directly onto the substrate. There is a continuous form of the process, in which the ink is pressed at a uniform rate through a nozzle and the jet is directed onto the substrate by an electric field depending on the pattern to be printed, and there is an interrupted or drop-on-demand process, in which the ink is expelled only where a colored dot is to appear, the latter form of the process employing either a piezoelectric crystal or a heated hollow needle (bubble or thermal jet process) to exert pressure on the ink system and so eject an ink droplet. These techniques are described in Text. Chem. Color 19 (1987), No. 8, 23-29, and 21 (1989), No. 6, 27-32.

The inks of the invention are particularly useful as inks for the bubble jet process or the process employing a piezoelectric crystal.

Useful substrate materials include:
cellulosic materials such as paper, paperboard, cardboard, wood and woodbase, which may each be lacquered or otherwise coated,
metallic materials such as foils, sheets or workpieces composed of aluminum, iron, copper, silver, gold, zinc or alloys thereof, which may each be lacquered or otherwise coated,
silicatic materials such as glass, porcelain and ceramic, which may likewise each be coated,
polymeric materials of any kind such as polystyrene, polyamides, polyesters, polyethylene, polypropylene, melamine resins, polyacrylates, polyacrylonitrile, polyurethanes, polycarbonates, polyvinyl chloride, polyvinyl alcohols, polyvinyl acetates, polyvinylpyrrolidones and corresponding copolymers including block copolymers, biodegradable polymers and natural polymers such as gelatin, leather—both natural and artificial—in the form of smooth leather, nappa leather or suede leather,
comestibles and cosmetics,
   and in particular
textile substrates and sheetlike structures such as wovens, knit fabric, woven fabric, nonwovens and made-up fabric composed for example of polyester, modified polyester, blend fabrics from more than two materials such as polyester blend wovens and cotton blend wovens, cellulosic materials such as cotton, jute, flax, hemp and ramie, viscose, wool, silk, polyamide, polyamide blend wovens, polyacrylonitrile, polyurethane, polytetrahydrofuran, triacetate, acetate, polycarbonate, polypropylene, polyvinyl chloride, polyester microfibers and glass fiber wovens.

Recording fluids according to the present invention and ink jet process inks according to the present invention have altogether advantageous performance properties, especially good start-of-print performance and good sustained use performance (kogation) and also good holdout, and produce printed images of high quality, i.e., of high brilliance and depth of shade and also high rub-, light-, water- and wet rubfastness, washfastness and also stability to chemical dry cleaning. They are particularly useful for printing coated and plain paper and also textile substrates.

A further embodiment of the present invention provides substrates, especially textile substrates, which have been printed by one of the abovementioned inventive processes and are notable for particularly crisply printed pictures or drawings and also excellent hand.

In a further embodiment of the present invention, at least two and preferably at least three different recording fluids according to the present invention can be combined into sets.

The invention is illustrated by working examples.

Unless otherwise stated, the solvents used for syntheses were dried by standard methods, see for example Autorenkollektiv Organikum, 3^{rd} reprint of 15^{th} edition, VEB Verlag der Wissenschaften, Leipzig 1984, chapter F: Reagenzienanhang (pages 782-809). Nitrogen was dried by passing it through a drying tower packed with CaCl₂ and a drying tower packed with blue gel.

Unless stated otherwise, water (e) hereinbelow always refers to water which has been rendered completely ion-free by deionization using ion exchangers.

1. Synthesis of Dispersing Binders

The polyesterdiol used in Examples 1.1 and 1.2 was in each case a polyesterdiol having a hydroxyl number of 140 mg KOH/g polyesterdiol, determined according to German industrial standard DIN 53240, obtainable from isophthalic acid, adipic acid and 1,4-cyclohexanedimethanol in a molar ratio of 1:1:2.2.

1.1. Synthesis of Dispersing Binder (dc.1)

6.85 g of neopentyl glycol, 7.03 g of dimethylolpropionic acid, 51.95 g of polyesterdiol and 53.01 g of 4,4′-diphenyl diisocyanate were dissolved in 118.74 g of tetrahydrofuran previously distilled over Na/benzophenone by a standard laboratory method. A drop of di-n-butyltin dilaurate was added and the reaction solution was brought to the boil. It was heated under reflux until free isocyanate was no longer detectable (titrimetrically in accordance with German industrial standard DIN 53 185). The reaction solution was then cooled down by means of an ice bath and admixed with a solution of 6.25 g of diethanolamine in 6.25 g of distilled tetrahydrofuran and then with 5.4 g of triethylamine. 315 g of water were added and the tetrahydrofuran was distilled off to leave dispersing binder (dc.1) in aqueous solution, solids content 33% by weight.

1.2 Sythesis of Dispersing Binder (dc.2)

22.7 g of neopentyl glycol, 23.6 g of dimethylolpropionic acid, 175.3 g of polyesterdiol and 178.4 g of 4,4′-diphenyl diisocyanate were dissolved in 400 g of acetone previously distilled over K₂CO₃ by a standard laboratory method. A drop of di-n-butyltin dilaurate was added and the reaction solution was brought to the boil. It was heated under reflux until free isocyanate was no longer detectable (titrimetrically in accordance with German industrial standard DIN 53 185). The reaction solution was then cooled down by means of an ice bath and admixed with a solution of 17.8 g of diethanolamine in 61.4 g of distilled acetone and then with 17.8 g of triethylamine. 500 g of water were added and the tetrahydrofuran was distilled off to leave dispersing binder (dc.2) in aqueous solution, solids content 33% by weight.

2. Production of Colorant Preparations

Each colorant preparation was produced as a grind by using a 100 ml capacity Skandex shaker filled with 60 g of glass balls 0.55 mm in average diameter.

2.1 Production of a Magenta Colorant Preparation F.1

The following ingredients were weighed into the shaker:

6.0 g of P.R. 122 pigment

18.02 g of dispersing binder (dc.1)

0.3 g of a 20% by weight solution of 1,2-benzisothiazolin-3-one in propylene glycol 2.69 g of melamine resin of formula IV.1 (stoichiometric ratio)

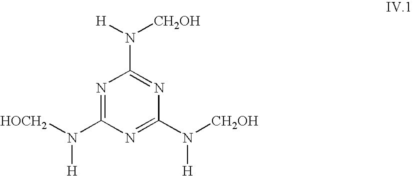

29.94 g of water

The mixture was shaken for 4 hours to produce the magenta colorant preparation F.1. The average particle diameter of the colorant was determined by means of a Coulter LS230 Coulter Counter as a number average diameter of 155 nm. Transmission electron microscopy (TEM) showed that not all colorant particles were completely polymer enveloped.

2.2 Production of a Blue Colorant Preparation F.2

The 2.1 procedure was repeated with 6.9 g of Pigment Blue 15:3 instead of P.R. 122. Shaking for 4 hours gave the blue colorant preparation F.2. The average particle diameter of the colorant was determined by means of a Coulter LS230 Coulter Counter as a number average diameter of 240 nm. Transmission electron microscopy showed that not all colorant particles were completely polymer enveloped.

2.3 Production of a Magenta Colorant Preparation F.3

The 2.1 procedure was repeated with 18.02 g of dc.2 instead of dc.1. Shaking for 4 hours gave the magenta colorant preparation F.3. The average particle diameter of the colorant was determined by means of a Coulter LS230 Coulter Counter as a number average diameter of 130 nm. Transmission electron microscopy showed that not all colorant particles were completely polymer enveloped.

2.4 Production of a Blue Colorant Preparation F.4

The 2.3 procedure was repeated with 6.9 g of Pigment Blue 15:3 instead of P.R. 122. Shaking for 4 hours gave the blue colorant preparation F.4. The average particle diameter of the colorant was determined by means of a Coulter LS230 Coulter Counter as a number average diameter of 145 nm. Transmission electron microscopy showed that not all colorant particles were completely polymer enveloped.

2.5 Production of a Red Colorant Preparation F.5 on the Basis of a Disperse Dye

The 2.1 procedure was repeated except that the following substances were mixed:

15 g of Disperse Red 60 dye

7.5 g of polyethylene glycol of molecular weight Mw of 600 g/mol

15 g of dispersant (c.1) (dispersing agent from Example 3 of U.S. Pat. No. 5,186,848)

0.5 g of triethanolamine

62 g of water

A red colorant preparation F.5 was obtained. The average particle diameter of the colorant was determined by means of a Coulter LS230 Coulter Counter as a number average diameter of 290 nm. The particles were not polymer covered.

2.6 Production of a Blue Colorant Preparation F.6 on the Basis of a Disperse Dye

The 2.5 procedure was repeated except that Disperse Red 60 was replaced by Disperse Blue 72. A blue colorant preparation F.6 was obtained. The average particle diameter of the colorant was determined by means of a Coulter LS230 Coulter Counter as a number average diameter of 250 nm. The particles were not polymer covered.

3. Production of Inventive Recording Fluids and of Comparative Fluids

General Protocol:

The ingredients of Table 1 were each added together in the order evident from the table and thoroughly mixed through by stirring. The addition of each colorant preparation was followed by a further 15 minutes of stirring. This was followed by filtration through a net 1 μm in pore size to obtain the inventive recording fluids (inks) as per Table 1.

TABLE 1
Production of inventive inks T.1 to T.7 and T.9 to T.10 and
of comparative inks V-T.11 to V-T.14

| | Colorant | | | | | |
|---|---|---|---|---|---|---|
| No. | preparation | (b1) | (b2) | (c) | (e) [g] | (f) |
| T.1 | 25 g F.1 | B1 (0.15 g) | B2 (0.2 g) | — | 55 | 3 g triethylene glycol mono-n-butyl ether, 7 g PE40, 8 g glycerol, |
| | | | | | | 0.15 g ethylene glycol, 0.5 g BIT, |
| T.2 | 25 g F.3 | B1 (0.5 g) | B2 (0.5 g) | — | 52 | 5 g P-THF, 7 g PE40, 8 g glycerol, 0.5 g ethylene glycol, 0.5 g BIT, |
| | | | | | | 1 g urea |
| T.3 | 25 g F.2 | B1 (0.5 g) | B4 (0.3 g) | — | 56.2 | 3 g triethylene glycol mono-n-butyl ether, 5 g 1,2-pentanediol, |
| | | | | | | 8 g glycerol, 0.5 g BIT, 0.5 g ethylene glycol, 1 g urea |
| T.4 | 25 g F.2 | B1 (0.5 g) | B2 (0.2 g) | — | 56.2 | 2 g PE40, 5 g 1,2-pentanediol, 8 g glycerol, 0.4 g BIT, 0.5 g |
| | | | | | | ethylene glycol, 1 g urea |
| T.5 | 25 g F.3 | B1 (0.5 g) | B5 (0.5 g) | — | 52.0 | 5 g P-THF, 7 g PE40, 8 g glycerol, 0.5 g BIT, 0.5 g ethylene glycol, |
| | | | | | | 1 g urea |
| T.6 | 25 g F.2 | B1 (1.2 g) | B4 (0.5 g) | — | 56.2 | 2 g PE40, 5 g 1,2-pentanediol, 8 g glycerol, 0.4 g BIT, 0.6 g |
| | | | | | | ethylene glycol, 1 g urea |
| T.7 | 25 g F.1 | B2 (1.0 g) | B5 (0.5 g) | — | 54.0 | 3 g triethylene glycol mono-n-butyl ether, 7 g PE40, 8 g glycerol, |
| | | | | | | 0.5 g BIT, 1 gurea |
| T.9 | 24.82 g F.5 | B4 (0.15 g) | B2 (0.4 g) | (c.1) | 57.35 | 7 g glycerol, 5 g PE40, 4 g 1,2-pentanediol, 0.48 g BIT |
| T.10 | 30.4 g F.6 | B4 (0.15 g) | B2 (0.1 g) | (c.1) | 52.37 | 6 g glycerol, 6 g PE40, 4.5 g 1,2-pentanediol, 0.48 g BIT |
| V-T.11 | 25 g F.1 | —(*) | — | — | 53.0 | 3 g triethylene glycol mono-n-butyl ether, 7 g PE40, |
| | | | | | | 8 g glycerol, 0.5 g BIT, 1 g urea |
| V-T.12 | 25 g F.2 | B1 (0.75 g) | — | — | 52.0 | 5 g P-THF, 7 g PE40, 8 g glycerol, 0.5 g BIT, |
| | | | | | | 0.75 g ethylene glycol, 1 g urea |
| V-T.13 | 25 g F.3 | B4 (1.3 g) | — | — | 56.2 | 3 g triethylene glycol mono-n-butyl ether, 5 g 1,2-pentanediol, |
| | | | | | | 8 g glycerol, 0.5 g BIT, 1 g urea |
| V-T.14 | 25 g F.3 | B2 (1.2 g) | — | — | 56.2 | 2 g PE40, 5 g 1,2-pentanediol, 8 g glycerol, 0.4 g BIT, |
| | | | | | | 1 g urea |

(*) the wetting agent used was 0.5 g of a wetting agent of the formula A2.1

A2.1

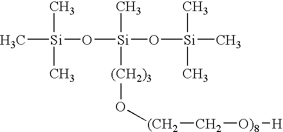

as described in EP 1 234 859.

Abbreviations used: PE40: polyethylene glycol having an Mw of 400 g/mol, BIT: 20% by weight solution of 1,2-benzisothiazolin-3-one in propylene glycol, P-THF: polytetrahydrofuran having an M_{w} of 250 g/mol

(c.1) is if present reported as constituents of the colorant preparation used and are recited for completeness only. 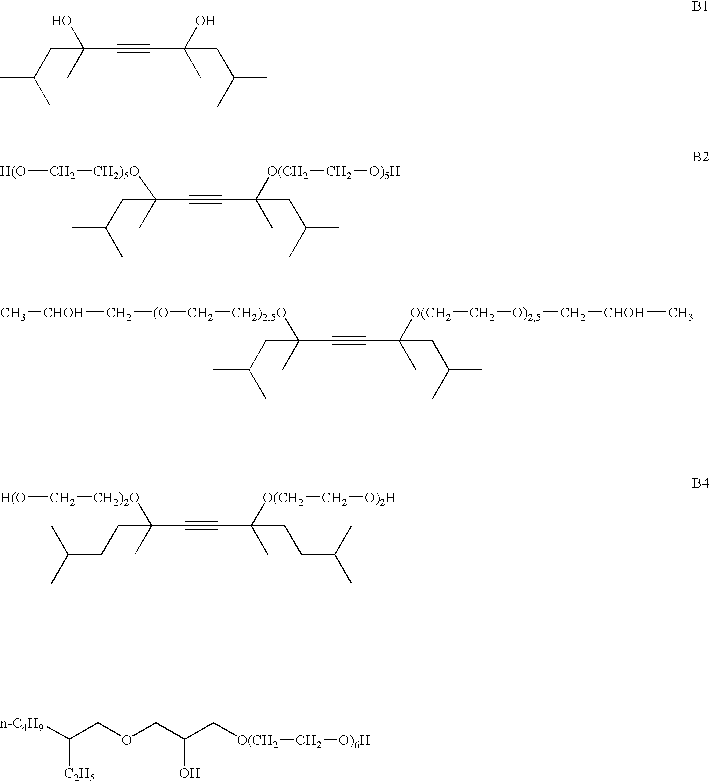
4. Printing Tests With Inventive Recording Fluids and With Comparative Fluids

The inventive recording fluids were each filled into one cartridge per recording fluid. Similarly, the comparative fluids were filled into one cartridge each.

Printing tests were carried out with a Mimaki TX2 ink jet printer on water-resistant ink jet paper. Each ink was used to print a solid area in 8 passes at a resolution of 720×720 dpi. The results are summarized in Table 2.

TABLE 2
Results of printing tests

| | | Nozzle result | | |
|---|---|---|---|---|
| Printing test No. | Recording fluid No. | Dropout | Misting | Comments |
| 4.1 | T.1 | 0 | 1 | — |
| V4.11 | V-T.11 | 12 | 20 | V-T.11 |
| | | | | foamy |
| 4.2 | T.2 | 0 | 2 | — |
| V4.12 | V-T.12 | 17 | 13 | V-T.12 |
| | | | | had oil |
| | | | | floating |
| | | | | on top |
| 4.3 | T.3 | 1 | 0 | — |
| 4.4 | T.4 | 0 | 3 | — |
| V4.14 | T-V.14 | 20 | 23 | V-T.14 |
| | | | | very foamy |
| 4.5 | T.5 | 2 | 1 | — |
| 4.6 | T.6 | 0 | 2 | — |
| 4.7 | T.7 | 0 | 1 | — |
| 4.9 | T.9 | 1 | 3 | — |
| 4.10 | T.10 | 0 | 2 | — |
| V4.13 | T.13 | 1 | 23 | — |

1. An aqueous recording fluid comprising
(a) at least one colorant that is not completely polymer enveloped, selected from those colorants in particulate form wherein some colorant particles are completely polymer enveloped and other particles are only incompletely polymer enveloped, and those colorants in particulate form wherein some colorant particles are completely polymer enveloped and other colorant particles are not polymer enveloped at all, and
(b) at least two wetting agents selected from alkoxylated alcohols of the formula R¹O(AO)ₓ—H, where R¹ is C₁-C₃₀-alkyl where one or else two nonadjacent CH₂ groups may be replaced by oxygen and wherein the C₁-C₃₀-alkyl may be unsubstituted or substituted with one or two hydroxyl groups, AO represents alkylene oxide selected from ethylene oxide, propylene oxide, and butylene oxide, and x is an integer from 1 to 100, alkoxylated acetylene alcohols, alkoxylated or nonalkoxylated acetylenediols, alkylpolyglucosides, sugar ester alkoxylates, fluorosurfactants, anionic surfactants and cationic surfactants.

2. The recording fluid according to claim 1, further comprising (c) at least one dispersant.

3. The recording fluid according to claim 1, further comprising two wetting agents (b1) and (b2) whose weight ratio is in the range from 1:20 to 20:1.

4. The recording fluid according to claim 1, comprising up to 2% by weight of (b), based on the total weight of the recording fluid.

5. The recording fluid according claim 1, further comprising (d) at least one binder.

6. A process for producing a recording fluid according to claim 1, which comprises mixing
(a) at least one colorant that is not completely polymer enveloped, selected from those colorants in particulate form wherein some colorant particles are completely polymer enveloped and other particles are only incompletely polymer enveloped, and those colorants in particulate form wherein some colorant particles are completely polymer enveloped and other colorant particles are not polymer enveloped at all, and
(b) at least 2 wetting agents selected from alkoxylated alcohols of the formula R¹O(AO)ₓ—H, where R¹ is C₁-C₃₀-alkyl where one or else two nonadjacent CH₂ groups may be replaced by oxygen and wherein the C₁-C₃₀-alkyl may be unsubstituted or substituted with one or two hydroxyl groups, AO represents alkylene oxide selected from ethylene oxide, propylene oxide and butylene oxide, and x is an integer from 1 to 100, alkoxylated acetylene alcohols, alkoxylated or nonalkoxylated acetylenediols, alkylpolyglucosides, sugar ester alkoxylates, fluorosurfactants, anionic surfactants and cationic surfactants,
(c) if appropriate at least one dispersant,
(d) if appropriate at least one binder,
(e) water and
(f) if appropriate further assistants
with each other in one or more steps.

7. An ink for an ink jet process comprising a recording fluid according to claim 1.

8. A process for printing substrates by the ink jet process comprising using a recording fluid according to claim 1.

9. The process according to claim 8 when the substrates are textile substrates.

10. A printed substrate obtained by a process according to claim 8.

11. An aqueous recording fluid comprising
(a) at least one colorant in which at least 0.1% by weight of the colorant particles are not completely polymer enveloped, and
(b) at least two wetting agents selected from alkoxylated alcohols of the formula R¹O(AO)ₓ—H, where R¹ is C₁-C₃₀-alkyl wherein one or else two nonadjacent CH₂ groups may be replaced by oxygen and wherein C₁-C₃₀-alkyl may be unsubstituted or substituted with one or two hydroxyl groups, AO represents alkylene oxide, selected from ethylene oxide, propylene oxide and butylene oxide and x is an integer from 1 to 100, alkoxylated acetylene alcohols, alkoxylated or nonalkoxylated acetylenediols, alkylpolyglucosides, sugar ester alkoxylates, fluorosurfactants, anionic surfactants and cationic surfactants.
